(19) United States
(12) Patent Application Publication
(10) Pub. No.: US 2026/0329577 A1
(43) Pub. Date: Oct. 22, 2026

(54) MIGRATING EXECUTION FLOWS FOR LEGACY APPLICATIONS USING MACHINE LEARNING MODELS

(71) Applicant: International Business Machines Corporation, Armonk, NY (US)

(72) Inventors: Yu Dong Wang, Xi'an (CN); Zhan Wei Wang, Xi'an (CN); Hui Liu, Xi'an (CN); Jia Xin Gao, Xi'an (CN); Shuai Zhang, Xi'an (CN)

(21) Appl. No.: 19/184,600

(22) Filed: Apr. 21, 2025

(51) Int. Cl. G06F 8/70

(52) U.S. Cl. CPC G06F 8/70

(57) ABSTRACT

A computer-implemented method is provided. A processor set receives a dataset comprising images of a number of execution flows for a number of legacy applications and a number of new applications. The processor set trains a number of machine learning models using the dataset. The number of machine learning models are trained for processing icons and execution properties from execution flows for the number of legacy applications and the number of new applications. The processor set identifies a set of legacy icons and a set of legacy execution flows in a number of images associated with a legacy application from the number of legacy applications using the number of machine learning models. The processor set generates a set of new icons and a new execution flow for a new application from the number of new applications based on the set of legacy icons and the set of legacy execution flows.

### BACKGROUND

The disclosure relates generally to migrating process flows for legacy applications using machine learning models.

Process flows are structured sequences of steps or activities that describe how a particular task or operation is carried out within a system or application. The process flows help illustrate how inputs are transformed into outputs through a series of defined actions, decisions, and transitions. In other words, process flows are commonly used in software developments and system design to provide a clear understanding of how tasks are performed and how different components interact. In this case, process flows can include execution flows that define how an application runs the operations defined in a process.

Legacy applications are older software systems that were developed using technologies, programming languages, or architectures that are no longer widely used or supported. Legacy process flows are process flows for legacy applications that involve use of older or outdated systems. Legacy process flows often follow traditional patterns that were created based on the technology constraints of the time. In this case, those legacy process flows may be tightly coupled with specific hardware, outdated software architecture, or older data formats.

### SUMMARY

According to one illustrative embodiment, a computer-implemented method is provided. A processor set receives a dataset comprising images of a number of execution flows for a number of legacy applications and a number of new applications. The number of execution flows comprise a number of icons for elements in the number of execution flows and execution properties for the number of execution flows. In addition, the number of new applications are upgraded versions for the number of legacy applications. The processor set trains a number of machine learning models using the dataset. The number of machine learning models are trained for processing icons and execution properties from execution flows for the number of legacy applications and the number of new applications. The processor set identifies a set of legacy icons and a set of legacy execution flows in a number of images associated with a legacy application from the number of legacy applications using the number of machine learning models. The processor set generates a set of new icons and a new execution flow for a new application from the number of new applications based on the set of legacy icons and the set of legacy execution flows. The new application is an upgraded version for the legacy application. According to other illustrative embodiments, a computer system and a computer program product are also provided.

### BRIEF DESCRIPTION OF THE DRAWINGS

FIG. 1 is a pictorial representation of a computing environment in which illustrative embodiments may be implemented;

FIG. 2 is an illustration of a block diagram of an application management environment in accordance with an illustrative embodiment;

FIG. 3 is an illustration of converting legacy icons for a legacy application to new icons of a new application for the legacy application in accordance with an illustrative embodiment;

FIG. 4 is an illustration of execution flow migration in accordance with an illustrative embodiment;

FIG. 5 is a flowchart of a process for generating new icons and a new execution flow for a new application in accordance with an illustrative embodiment;

FIG. 6 is a flowchart of a process for training the number of machine learning models in accordance with an illustrative embodiment;

FIG. 7 is a flowchart of a process for normalizing images of the number of execution flows in accordance with an illustrative embodiment;

FIG. 8 is a flowchart of a process for generating new icons and the new execution flow for the new application in accordance with an illustrative embodiment; and

FIG. 9 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one or more storage media (also called "mediums") collectively included in a set of one or more storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

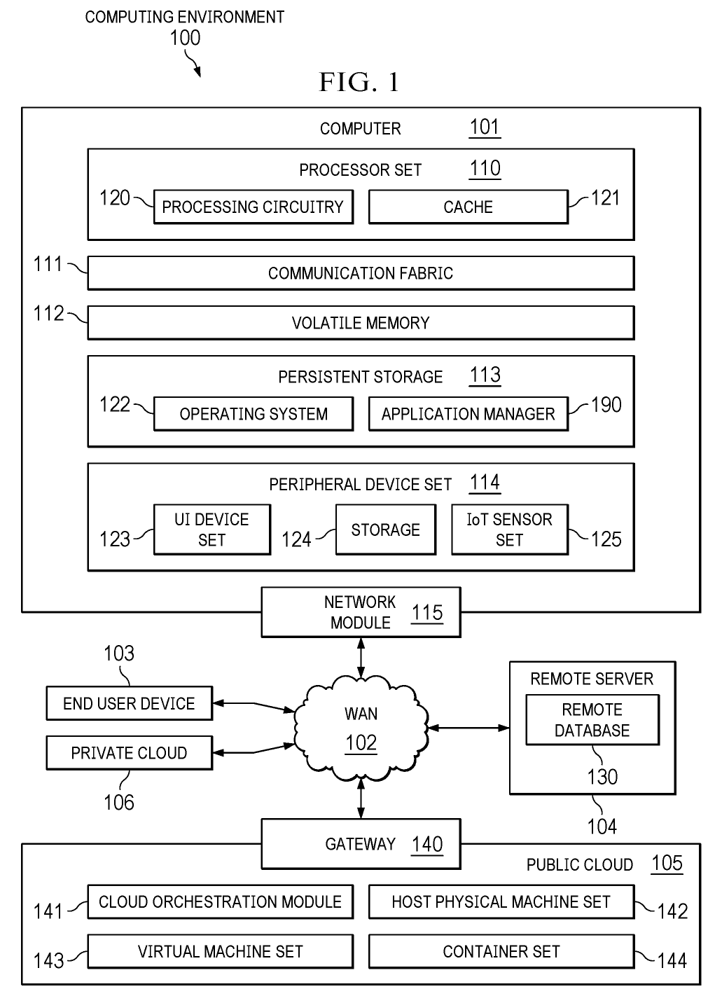

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as application manager 190. In addition to application manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and application manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in application manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in application manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that there is a continuous need to migrate process flows from legacy applications to applications on a next-generation platform. The illustrative embodiments recognize and take into account that process flow migration is a complex work that requires vast amounts of labor to manually draw each flow on the new platform.

The illustrative embodiments also recognize and take into account that data in process flows are usually constructed in XML/JSON format. In this case, the process flow migration becomes complex or even impossible if the data structure for the process flows is not well designed.

Thus, illustrative embodiments of the present invention provide a computer implemented method, computer system, and computer program product. A processor set receives a dataset comprising images of a number of execution flows for a number of legacy applications and a number of new applications. The number of execution flows comprise a number of icons for elements in the number of execution flows and execution properties for the number of execution flows. In addition, the number of new applications are upgraded versions for the number of legacy applications. The processor set trains a number of machine learning models using the dataset. The number of machine learning models are trained for processing icons and execution properties from execution flows for the number of legacy applications and the number of new applications. The processor set identifies a set of legacy icons and a set of legacy execution flows in a number of images associated with a legacy application from the number of legacy applications using the number of machine learning models. The processor set generates a set of new icons and a new execution flow for a new application from the number of new applications based on the set of legacy icons and the set of legacy execution flows. The new application is an upgraded version for the legacy application.

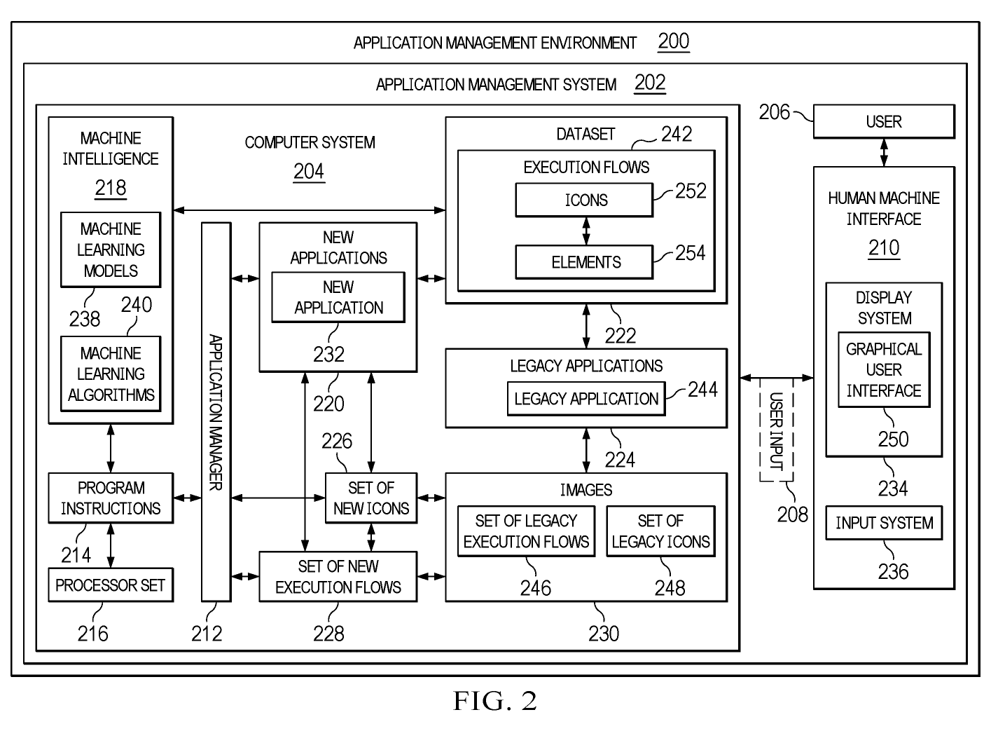

With reference now to FIG. 2, an illustration of a block diagram of an application management environment is depicted in accordance with an illustrative embodiment. In this illustrative example, application management environment 200 includes components that can be implemented in hardware such as the hardware shown in computing environment 100 in FIG. 1.

In this illustrative example, application management system 202 in application management environment 200 can be used for converting legacy execution flows for legacy applications to new execution flows for new applications. As depicted, legacy applications such as legacy applications 224 are old software programs or systems that are still in use but built with outdated technologies, programming languages, or architecture. In addition, new applications such as new applications 220 are upgraded versions of the legacy applications such as legacy applications 224. For example, the new applications can be versions of the legacy applications implemented on a cloud platform. The cloud platform can be an environment that provides computing resources, services, and tools over the internet to allow users to build, deploy, and manage applications without needing to own or maintain physical hardware.

In this illustrative example, application management system 202 includes computer system 204 which includes application manager 212. Application manager 212 is located in computer system 204. Application manager 212 may be implemented using application manager 190 in FIG. 1.

Application manager 212 can be implemented in software, hardware, firmware, or a combination thereof. When software is used, the operations performed by application manager 212 can be implemented in program instructions configured to run on hardware, such as a processor unit. When firmware is used, the operations performed by application manager 212 can be implemented in program instructions and data and stored in persistent memory to run on a processor unit. When hardware is employed, the hardware can include circuits that operate to perform the operations in application manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, application manager 212 can receive dataset 222 that includes images of execution flows 242 for legacy applications 224 and new applications 220. In this example, execution flows 242 are sequences of steps or operations that legacy applications 224 perform during operations. In this example, execution flows 242 indicate how control and data move through different components of legacy applications 224 and new applications 220 and interrelationships between different components within legacy applications 224 and new applications 220.

In this illustrative example, execution flows 242 include icons 252 associated with elements 254 for execution flows 242. In this example, elements 254 are representations for different components of legacy applications 224. In addition, icons 252 are visualizations for different components of legacy applications 224.

As depicted, computer system 204 includes machine intelligence 218. Machine intelligence 218 can include a number of machine learning models 238 and machine learning algorithms 240. The number of machine learning models 238 is a branch of artificial intelligence (AI) that enables computers to detect patterns and improve performance without direct programming commands. Rather than relying on direct input commands to complete a task, the number of machine learning models 238 relies on input data. The data is fed into the machine, one of machine learning algorithms 240 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning, unsupervised machine learning, or semi-supervised machine learning so that products or assets that do not match descriptively can nevertheless be matched. Over time, the data model from machine learning can provide a greater degree of flexibility in matching machine intelligence 218. It should be understood that in a production environment, attempts that may lead to failure are generally not allowed. In this illustrative example, refinement for machine intelligence 218 can be achieved by rewarding or penalizing the number of machine learning models 238 based on the difference between predicted and actual values. Ultimately, this process helps the number of machine learning models 238 to improve their predictive ability to meet the required confidence.

Machine intelligence 218 can be implemented using one or more systems such as an artificial intelligence system, a neural network, a generative neural network, a Bayesian network, an expert system, a fuzzy logic system, a genetic algorithm, or other suitable types of systems.

The number of machine learning models 238 involves using machine learning algorithms 240 to build computation models based on samples of data. The samples of data used for training are referred to as training data or training datasets. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications. In this illustrative example, the number of machine learning models 238 can be trained using dataset 222 such that the number of machine learning models 238 can be trained for processing icons and execution properties from execution flows for legacy applications 224 and new applications 220.

In an alternative example, dataset 222 can be split into a training dataset and a validation dataset. In this illustrative example, the training dataset can be used by machine intelligence 218 for learning patterns and relationships for dataset 222. On the other hand, the validation dataset is used to evaluate performance of the number of machine learning models 238 during the training process. In addition, the validation dataset can be used to tune hyperparameters such as the learning rate and number of layers to improve a generalization ability for the number of machine learning models 238.

In this illustrative example, machine learning algorithms 240 can include supervised machine learning algorithms and unsupervised machine learning algorithms. Supervised machine learning can train machine learning models using data containing both the inputs and desired outputs. Examples of machine learning algorithms include Gradient Boosting algorithm, XGBoost, K-means clustering, and Random Forest algorithm.

In this illustrative example, the number of machine learning models 238 can be retrained or updated using new data or outputs generated by the number of machine learning models 238 such that parameters in machine learning algorithms 240 selected for the number of machine learning models 238 can be adjusted to improve accuracy and efficiency of the number of machine learning models 238.

In this illustrative example, the number of machine learning models 238 can be implemented by selecting a pre-trained convolutional neural network as backbone network. In this illustrative example, the number of machine learning models 238 can further include a region proposal network and a number of region of interest pooling layers. In this example, such setup for the number of machine learning models 238 can also be referred to as “Faster R-CNN”, which can be used for object detections for images.

In this illustrative example, application manager 212 can further normalize dataset 222 before dataset 222 is used for training the number of machine learning models 238. In this example, application manager 212 can normalize pixel values for the images for execution flows 242 and resize the images for execution flows 242 to a consistent size. In addition, a number of data augmentation techniques can be applied to the images for execution flows 242 to increase the diversity of dataset 222. For example, the number of data augmentation techniques can include at least one of random cropping, rotation, flipping, brightness adjustment, or brightness contrast.

As a result, the number of machine learning models 238 can be used for identifying execution flows and icons for legacy applications 224 and new applications 220. In addition, the number of machine learning models 238 can be used for converting execution flows and icons between legacy applications 224 and new applications 220.

In this illustrative example, application manager 212 uses the number of machine learning models 238 to identify set of legacy execution flows 246 and set of legacy icons 248 from images 230. In this illustrative example, images 230 contain information associated with legacy application 244 from legacy applications 224. In other words, set of legacy execution flows 246 and set of legacy icons 248 are execution flows and icons for legacy application 244 that can be identified by the number of machine learning models 238. In an alternative illustrative example, set of legacy execution flows 246 and set of legacy icons 248 can be annotated using bounding boxes on images 230.

In this example, application manager 212 uses the number of machine learning models 238 to generate set of new icons 226 and set of new execution flows 228 for new application 232 from new applications 220. In this illustrative example, new application 232 can be an upgraded version for legacy application 244. In other words, the number of machine learning models 238 can migrate icons and execution flows that are used for legacy application 244 to new application 232 in the form of set of new icons 226 and set of new execution flows 228.

In this illustrative example, set of new icons 226 and set of new execution flows 228 for new application 232 can be generated in a number of ways. For example, application manager 212 can use the number of machine learning models 238 to identify icons and execution flows associated with legacy application 244 from images 230 as set of legacy execution flows 246 and set of legacy icons 248. Subsequently, application manager 212 can use the number of machine learning models 238 to generate set of new icons 226 and set of new execution flows 228 for new application 232. In this example, set of new icons 226 are icons that correspond to set of legacy icons 248 and set of new execution flows 228 are execution flows correspond to set of legacy execution flows 246. In this illustrative example, set of new icons 226 and set of new execution flows 228 are configured using formats used for new application 232.

In this illustrative example, user 206 can interact with computer system 204 through user inputs to computer system 204. In this illustrative example, user input 208 can be generated by user 206 using human machine interface (HMI) 210. As depicted, human machine interface 210 includes display system 234 and input system 236. Display system 234 is a physical hardware system and includes one or more display devices on which graphical user interface 250 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 250 through user input 208 generated by input system 236. Input system 236 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, user 206 can view dataset 222, execution flows 242, images 230, set of new icons 226, and set of new execution flows 228 through graphical user interface 256.

In one illustrative example, one or more solutions are present that overcome a problem with migrating execution flows from legacy applications to new applications for the legacy applications. Specifically, such migration can be achieved by using machine learning models through object detection and image recognition. As a result, one or more technical solutions may provide an ability to increase efficiency and performance in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which application manager 212 in computer system 204 enables migration of execution flows from legacy applications to new applications for the legacy applications. In particular, application manager 212 transforms computer system 204 into a special purpose computer system as compared to currently available general computer systems that do not have application manager 212.

In the illustrative example, the use of application manager 212 in computer system 204 integrates processes into a practical application for migrating execution flows from legacy applications to new applications for the legacy applications. In other words, application manager 212 in computer system 204 is directed to a practical application of processes integrated into application manager 212 in computer system 204 that supports migration of execution flows from legacy applications to new applications for the legacy applications.

For example, migrating execution flows from legacy applications to newer versions of the legacy applications improves computer functioning by introducing more efficient and optimized sequences of operations. In legacy applications, the execution flows are often rigid, linear, and resource dependent. These flows may include outdated methods of accessing memory, interacting with files, or communicating with hardware, which can slow down the overall system. By transitioning to newer applications or modern applications, the execution flows are restructured to better align with how modern computers operate, which further leads to reduced overhead and faster and more efficient use of the system.

In addition, execution flows in modern applications are often modular and event driven. This allows the computer to allocate resources only when needed, reducing constant background activity and preventing bottlenecks. As a result, the computer’s processor, memory, and storage systems are used more effectively. Additionally, execution flows for modern applications are built to take advantage of newer hardware features, which older execution flows cannot fully utilize. In this example, tasks are completed more quickly and require less energy when execution flows are optimized for such hardware. This further leads to better overall computer performance and stability.

The illustration of application management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, conversion of legacy execution flows and legacy icons to new execution flows and new icons can be performed for applications other than legacy application 244 and new application 232. In addition, the number of machine learning models 238 can also be retrained when dataset 222 is updated with information associated with applications other than new applications 220 and legacy applications 224.

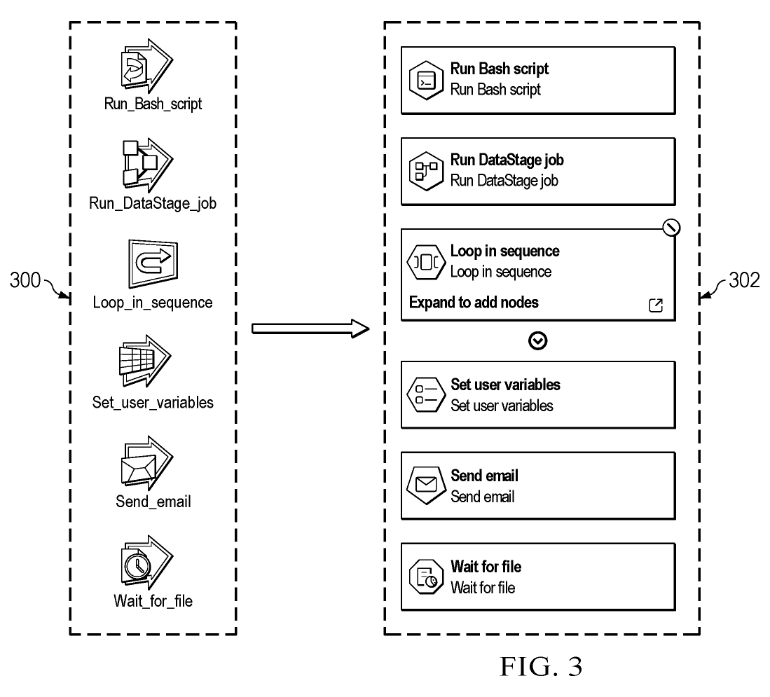

With reference now to FIG. 3, an illustration of converting legacy icons for a legacy application to new icons of a new application for the legacy application is shown in accordance with an illustrative embodiment. In this illustrative example, legacy icons 300 can be examples of set of legacy icons 248 in FIG. 2, new icons 302 can be examples of set of new icons 226 in FIG. 2, and conversion or migration of legacy icons 300 to new icons 302 can be implemented using application manager 212 in FIG. 2.

In FIG. 3, legacy icons 300 includes a number of visualizations that are designed for a legacy application. In contrast, new icons 302 includes a number of new visualizations that are designed for a new application. In this illustrative example, the new application that is associated with new icons 302 is an upgraded version of the legacy application that is associated with legacy icons 300. For example, the new application can be a version of the legacy application implemented on a cloud platform. The cloud platform can be an environment that provides computing resources, services, and tools over the internet to allow users to build, deploy, and manage applications without needing to own or maintain physical hardware.

In this illustrative example, each visualization from the number of visualizations in legacy icons 300 corresponds to a new visualization from the number of new visualizations for new icons 302. For example, legacy icon of “Run_Bash_script” is converted to a new icon of “Run_Bash_script”, as illustrated in new icons 302. In another example, legacy icon of “Send_email” is converted to a new icon of “Send_ email”, as illustrated in new icons 302.

In this illustrative example, the conversion from legacy icons 300 to new icons 302 can be performed using a machine learning model such as machine learning models 238 in FIG. 2. In this example, the machine learning model is trained using images of a number of execution flows for the legacy application and the new application. As a result, the machine learning model is capable of recognizing legacy icons in the legacy application and converting those legacy icons to their corresponding new icons that can be used in the new application.

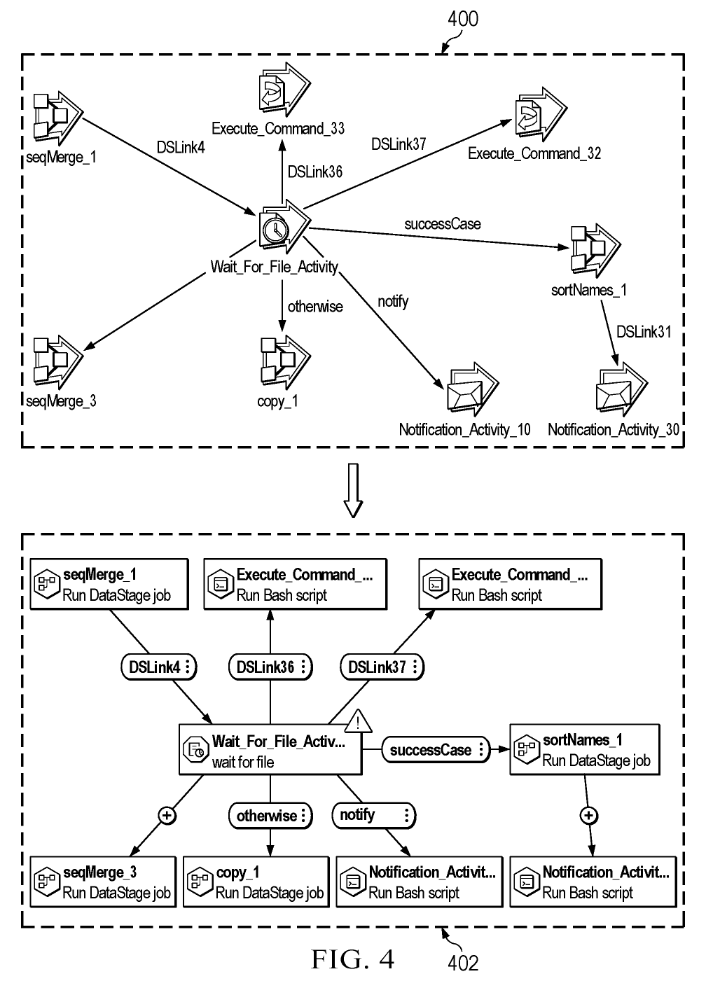

With reference now to FIG. 4, an illustration execution flow migration is shown in accordance with an illustrative embodiment. In this illustrative example, legacy execution flow 400 can be an example of images 230 for set of legacy execution flows 246 in FIG. 2, and new execution flow 402 can be an example of new execution flows 228 in FIG. 2.

In a similar fashion, the conversion from legacy execution flow 400 to new execution flow 402 can be performed using a machine learning model such as machine learning models 238 in FIG. 2. As depicted, the machine learning model is trained using images of a number of execution flows for the legacy application and the new application. The machine learning model is capable of recognizing legacy execution flows in the legacy application and converting those legacy execution flows to their corresponding new execution flows that can be used in the new application.

In this illustrative example, legacy icons in legacy execution flow 400 can be identified by the machine learning model and converted to new icons as shown in new execution flow 400. In this illustrative example, legacy execution flow 400 can be an execution flow for a legacy application and new execution flow 402 can be an execution flow for a new application that is an upgraded version of the legacy application. In other words, legacy execution flow 400 is migrated to the new application as new execution flow 402 such that the converted execution flow can be used or visualized in the new application.

The illustration of execution flows in FIG. 4 are not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, legacy execution flow 400 and new execution flow 402 can be structured in other formats using other icons.

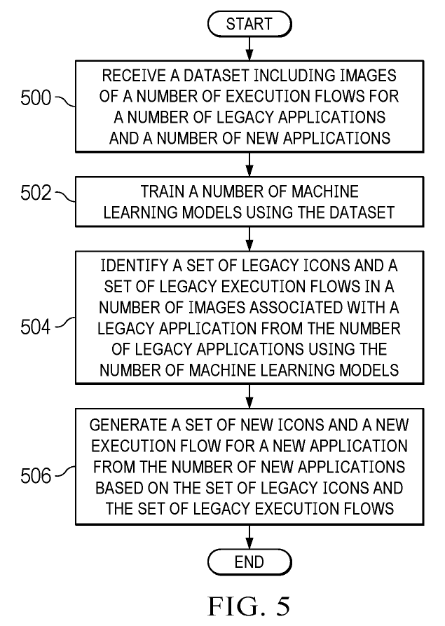

With reference now to FIG. 5, a flowchart illustrating a process for generating new icons and a new execution flow for a new application is depicted in accordance with an illustrative embodiment. The process in FIG. 5 can be implemented in hardware, software, or both. When implemented in software, the process can take the form of program instructions that are run by one of more processor units located in one or more hardware devices in one or more computer systems. For example, the process can be implemented in application manager 212 in computer system 204 in FIG. 2.

The process begins by receiving a dataset including images of a number of execution flows for a number of legacy applications and a number of new applications (step 500). In step 500, the number of execution flows include a number of icons for elements in the number of execution flows and execution properties for the number of execution flows. In addition, the number of new applications are upgraded versions for the number of legacy applications.

The process trains a number of machine learning models using the dataset (step 502). The number of machine learning models are trained for processing icons and execution properties from execution flows for the number of legacy applications and the number of new applications.

The process identifies a set of legacy icons and a set of legacy execution flows in a number of images associated with a legacy application from the number of legacy applications using the number of machine learning models (step 504). The process generates a set of new icons and a new execution flow for a new application from the number of new applications based on the set of legacy icons and the set of legacy execution flows (step 506). In step 506, the new application is an upgraded version for the legacy application. The process terminates thereafter.

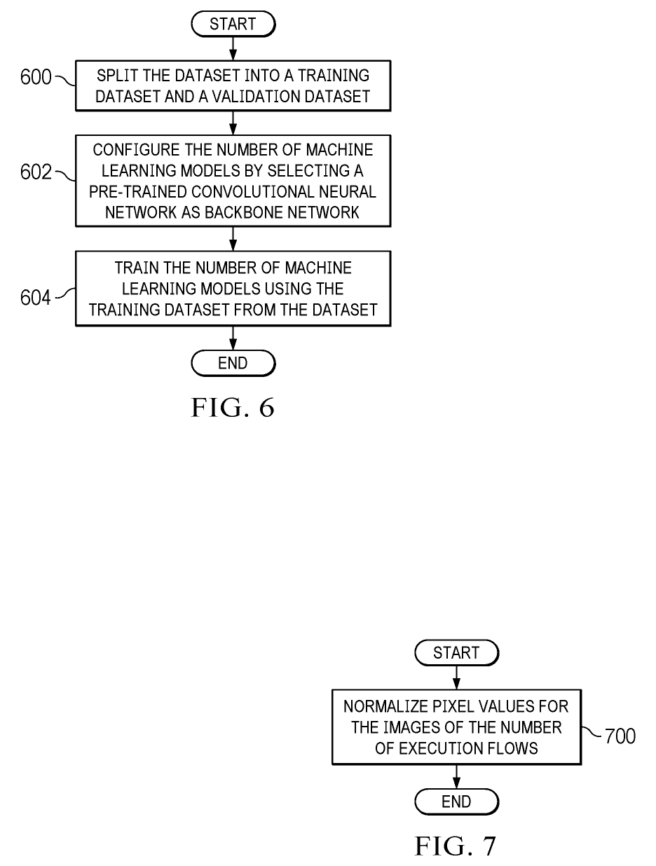

With reference now to FIG. 6, a flowchart illustrating a process for training the number of machine learning models is shown in accordance with an illustrative embodiment. The process in this flowchart is an example of an implementation for step 502 in FIG. 5.

The process begins by splitting the dataset into a training dataset and a validation dataset (step 600). The process configures the number of machine learning models by selecting a pre-trained convolutional neural network as backbone network (step 602). In step 602, the number of machine learning models can further include a region proposal network and a number of region of interest pooling layers. In this illustrative example, the number of machine learning models can be implemented using Faster Region-Convolutional Neural Network (Faster R-CNN). The process trains the number of machine learning models using the training dataset from the dataset (step 604). The process terminates thereafter.

With reference now to FIG. 7, a flowchart illustrating a process for normalizing images of the number of execution flows is shown in accordance with an illustrative embodiment. The process in this figure is an example of an additional step that can be performed with the steps in FIG. 6.

The process begins by normalizing pixel values for the images of the number of execution flows (step 700). In this step, the images of the number of execution flows are resized to a consistent size. The process terminates thereafter.

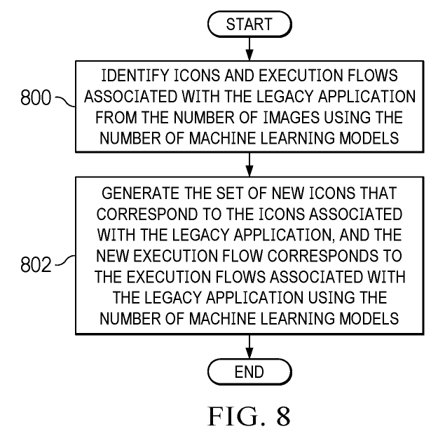

With reference now to FIG. 8, a flowchart illustrating a process for generating new icons and the new execution flow for the new application is shown in accordance with an illustrative embodiment. The process in this flowchart is an example of an implementation for step 506 in FIG. 5.

The process begins by identifying icons and execution flows associated with the legacy application from the number of images using the number of machine learning models (step 800). The process generates the set of new icons that correspond to the icons associated with the legacy application, and the new execution flow corresponds to the execution flows associated with the legacy application using the number of machine learning models (step 802). In this step, the set of new icons and the new execution flow are configured using formats for the new application. The process terminates thereafter.

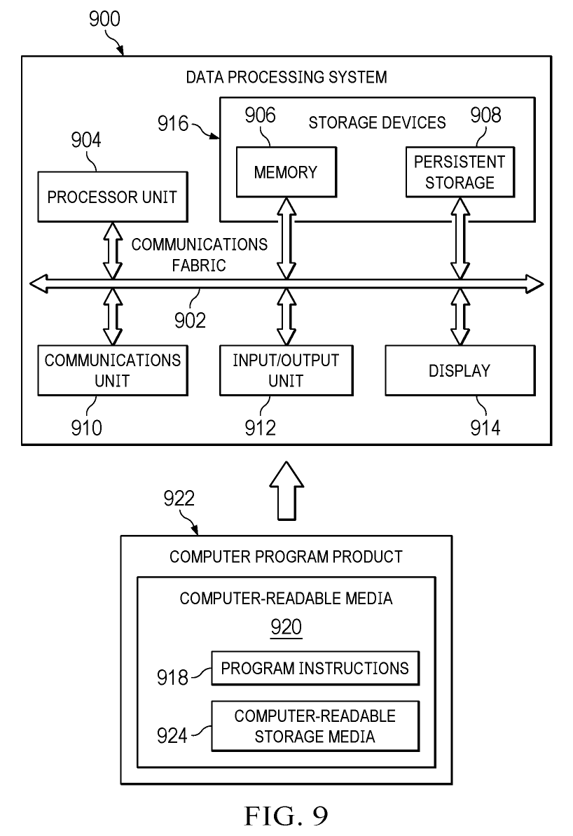

Turning now to FIG. 9, a block diagram of a data processing system is depicted in accordance with an illustrative embodiment. Data processing system 900 can be used to implement computers and computing devices in computing environment 100 in FIG. 1. Data processing system 900 can also be used to implement computer system 204 in FIG. 2. In this illustrative example, data processing system 900 includes communications framework 902 which provides communications between processor unit 904, memory 906, persistent storage 908, communications unit 910, input/output (I/O) unit 912, and display 914. In this example, communications framework 902 takes the form of a bus system.

Processor unit 904 serves to execute instructions for software that can be loaded into memory 906. Processor unit 904 includes one or more processors. For example, processor unit 904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 904 can be implemented using one or more heterogeneous processor systems in which a main processor is present with secondary processors on a single chip. As another illustrative example, processor unit 904 can be a symmetric multi-processor system containing multiple processors of the same type on a single chip.

Memory 906 and persistent storage 908 are examples of storage devices 916. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 916 may also be referred to as computer-readable storage devices in these illustrative examples. Memory 906, in these examples, can be, for example, a random-access memory or any other suitable volatile or non-volatile storage device. Persistent storage 908 may take various forms, depending on the particular implementation.

For example, persistent storage 908 may contain one or more components or devices. For example, persistent storage 908 can be a hard drive, a solid-state drive (SSD), a flash memory, a rewritable optical disk, a rewritable magnetic tape, or some combination of the above. The media used by persistent storage 908 also can be removable. For example, a removable hard drive can be used for persistent storage 908.

Communications unit 910, in these illustrative examples, provides for communications with other data processing systems or devices. In these illustrative examples, communications unit 910 is a network interface card.

Input/output unit 912 allows for input and output of data with other devices that can be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs can be located in storage devices 906, which are in communication with processor unit 904 through communications framework 902. The processes of the different embodiments can be performed by processor unit 904 using computer-implemented instructions, which may be located in a memory, such as memory 906.

These instructions are referred to as program instructions, computer usable program instructions, or computer-readable program instructions that can be read and executed by a processor in processor unit 904. The program instructions in the different embodiments can be embodied on different physical or computer-readable storage media, such as memory 906 or persistent storage 908.

Program instructions 918 are located in a functional form on computer- readable media 920 that is selectively removable and can be loaded onto or transferred to data processing system 900 for execution by processor unit 904. Program instructions 918 and computer-readable media 920 form computer program product 9 22 in these illustrative examples. In the illustrative example, computer-readable media 920 is computer-readable storage media 924.

Computer-readable storage media 924 is a physical or tangible storage device used to store program instructions 918 rather than a medium that propagates or transmits program instructions 918 Computer-readable storage media 924, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 918 can be transferred to data processing system 900 using a computer-readable signal media. The computer-readable signal media are signals and can be, for example, a propagated data signal containing program instructions 918. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 920” can be singular or plural. For example, program instructions 918 can be located in computer-readable media 920 in the form of a single storage device or system. In another example, program instructions 918 can be located in computer-readable media 920 that is distributed in multiple data processing systems. In other words, some instructions in program instructions 918 can be located in one data processing system while other instructions in program instructions 918 can be located in another data processing system. For example, a portion of program instructions 918 can be located in computer-readable media 920 in a server computer while another portion of program instructions 918 can be located in computer-readable media 920 located in a set of client computers.

The different components illustrated for data processing system 900 are not meant to provide architectural limitations to the manner in which different embodiments can be implemented. In some illustrative examples, one or more of the components may be incorporated in or otherwise form a portion of another component. For example, memory 906, or portions thereof, may be incorporated in processor unit 904 in some illustrative examples. The different illustrative embodiments can be implemented in a data processing system including components in addition to or in place of those illustrated for data processing system 900. Other components shown in FIG. 9 can be varied from the illustrative examples shown. The different embodiments can be implemented using any hardware device or system capable of running program instructions 918.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method comprising:
receiving, by a processor set, a dataset comprising images of a number of execution flows for a number of legacy applications and a number of new applications, wherein the number of execution flows comprise a number of icons for elements in the number of execution flows and execution properties for the number of execution flows, and wherein the number of new applications are upgraded versions for the number of legacy applications;
training, by the processor set, a number of machine learning models using the dataset, wherein the number of machine learning models are trained for processing icons and execution properties from execution flows for the number of legacy applications and the number of new applications;
identifying, by the processor set using the number of machine learning models, a set of legacy icons and a set of legacy execution flows in a number of images associated with a legacy application from the number of legacy applications; and
generating, by the processor set, a set of new icons and a new execution flow for a new application from the number of new applications based on the set of legacy icons and the set of legacy execution flows, wherein the new application is an upgraded version for the legacy application.

2. The computer implemented method of claim 1, wherein the training, by the processor set, the number of machine learning models using the dataset comprises:
splitting, by the processor set, the dataset into a training dataset and a validation dataset;
configuring, by the processor set, the number of machine learning models by selecting a pre-trained convolutional neural network as backbone network; and
training, by the processor set, the number of machine learning models using the training dataset from the dataset.

3. The computer implemented method of claim 2, wherein the number of machine learning models further comprise a region proposal network and a number of region of interest pooling layers.

4. The computer implemented method of claim 2, further comprising:
normalizing, by the processor set, pixel values for the images of the number of execution flows, wherein the images of the number of execution flows are resized to a consistent size.

5. The computer implemented method of claim 4, wherein a number of data augmentation techniques are applied to the images of the number of execution flows, wherein the number of data augmentation techniques comprise at least one of random cropping, rotation, flipping, brightness adjustment, and brightness contrast.

6. The computer implemented method of claim 1, wherein the number of icons for the elements in the number of execution flows and execution properties for the number of execution flows are annotated using bounding boxes.

7. The computer implemented method of claim 1, wherein the generating, by the processor set, a set of new icons and a new execution flow for a new application from the number of new applications based on the set of legacy icons and the set of legacy execution flows comprises:
identifying, by the processor set using the number of machine learning models, icons and execution flows associated with the legacy application from the number of images; and
generating, by the processor set using the number of machine learning models, the set of new icons that correspond to the icons associated with the legacy application, and the new execution flow corresponds to the execution flows associated with the legacy application, wherein the set of new icons and the new execution flow are configured using formats for the new application.

8. A computer system comprising:
a processor set;
a set of one or more computer-readable storage media; and
program instructions stored on the set of one or more storage media to cause the processor set to perform operations comprising:
receiving a dataset comprising images of a number of execution flows for a number of legacy applications and a number of new applications, wherein the number of execution flows comprise a number of icons for elements in the number of execution flows and execution properties for the number of execution flows, and wherein the number of new applications are upgraded versions for the number of legacy applications;
training a number of machine learning models using the dataset, wherein the number of machine learning models are trained for processing icons and execution properties from execution flows for the number of legacy applications and the number of new applications;
identifying a set of legacy icons and a set of legacy execution flows in a number of images associated with a legacy application from the number of legacy applications using the number of machine learning models; and
generating a set of new icons and a new execution flow for a new application from the number of new applications based on the set of legacy icons and the set of legacy execution flows, wherein the new application is an upgraded version for the legacy application.

9. The computer system of claim 8, wherein the training the number of machine learning models using the dataset comprises:
splitting the dataset into a training dataset and a validation dataset;
configuring the number of machine learning models by selecting a pre-trained convolutional neural network as backbone network; and
training the number of machine learning models using the training dataset from the dataset.

10. The computer system of claim 9, wherein the number of machine learning models further comprise a region proposal network and a number of region of interest pooling layers.

11. The computer system of claim 9, wherein the operations further comprise:
normalizing pixel values for the images of the number of execution flows, wherein the images of the number of execution flows are resized to a consistent size.

12. The computer system of claim 11, wherein a number of data augmentation techniques are applied to the images of the number of execution flows, wherein the number of data augmentation techniques comprise at least one of random cropping, rotation, flipping, brightness adjustment, and brightness contrast.

13. The computer system of claim 10, wherein the number of icons for the elements in the number of execution flows and execution properties for the number of execution flows are annotated using bounding boxes.

14. The computer system of claim 10, wherein the generating a set of new icons and a new execution flow for a new application from the number of new applications based on the set of legacy icons and the set of legacy execution flows comprises:
identifying icons and execution flows associated with the legacy application from the number of images using the number of machine learning models; and
generating the set of new icons that correspond to the icons associated with the legacy application, and the new execution flow corresponds to the execution flows associated with the legacy application using the number of machine learning models, wherein the set of new icons and the new execution flow are configured using formats for the new application.

15. A computer program product comprising:
a set of one or more computer-readable storage media;
program instructions stored in the set of one or more computer-readable storage media to perform operations comprising:
receiving, by a processor set, a dataset comprising images of a number of execution flows for a number of legacy applications and a number of new applications, wherein the number of execution flows comprise a number of icons for elements in the number of execution flows and execution properties for the number of execution flows, and wherein the number of new applications are upgraded versions for the number of legacy applications;
training, by the processor set, a number of machine learning models using the dataset, wherein the number of machine learning models are trained for processing icons and execution properties from execution flows for the number of legacy applications and the number of new applications;
identifying, by the processor set using the number of machine learning models, a set of legacy icons and a set of legacy execution flows in a number of images associated with a legacy application from the number of legacy applications; and
generating, by the processor set, a set of new icons and a new execution flow for a new application from the number of new applications based on the set of legacy icons and the set of legacy execution flows, wherein the new application is an upgraded version for the legacy application.

16. The computer program product of claim 15, wherein the training, by the processor set, the number of machine learning models using the dataset comprises:
splitting, by the processor set, the dataset into a training dataset and a validation dataset;
configuring, by the processor set, the number of machine learning models by selecting a pre-trained convolutional neural network as backbone network; and
training, by the processor set, the number of machine learning models using the training dataset from the dataset.

17. The computer program product of claim 16, wherein the number of machine learning models further comprise a region proposal network and a number of region of interest pooling layers.

18. The computer program product of claim 17, wherein the operations further comprise:
normalizing, by the processor set, pixel values for the images of the number of execution flows, wherein the images of the number of execution flows are resized to a consistent size.

19. The computer program product of claim 18, wherein a number of data augmentation techniques are applied to the images of the number of execution flows, wherein the number of data augmentation techniques comprise at least one of random cropping, rotation, flipping, brightness adjustment, and brightness contrast.

20. The computer program product of claim 15, wherein the number of icons for the elements in the number of execution flows and execution properties for the number of execution flows are annotated using bounding boxes.
